(19) United States
(12) Patent Application Publication
(10) Pub. No.: US 2007/0183091 A1
(43) Pub. Date: Aug. 9, 2007

(54) Read/write head having varying wear regions and methods of manufacture

(76) Inventor: George A. Saliba, Northborough, MA (US)

Correspondence Address: MORRISON & FOERSTER LLP, 755 PAGE MILL RD, PALO ALTO, CA, 94304-1018, US

(21) Appl. No.: 11/347,489

(22) Filed: Feb. 3, 2006

(51) Int. Cl. G11B 5/127; G11B 5/187

(52) U.S. Cl. 360/122; 360/125

(57) ABSTRACT

An exemplary magnetic head structure and method of manufacture is described. In one example, the method includes forming a support surface having a longitudinal width associated with at least one data transducer and a reduced longitudinal width region offset along a lateral direction from the at least one data transducer. The method further includes lapping the support surface such that the at least one data transducer is raised or elevated relative to at least a portion of the support surface. In one example, the at least one data transducer is raised relative to laterally offset portions of the support surface, and in one example, to laterally offset portions positioned between adjacent data transducers.

### BACKGROUND

1. Field

The present invention relates generally to magnetic read/write heads and in one example relates to a magnetic read/write head having varying wear regions laterally offset from an active device region including read/write transducer elements.

2. Description of Related Art

Magnetic tape continues to be an efficient and effective medium for data storage in computer systems. Increased data storage capacity and retrieval performance is desired of all commercially viable mass storage devices and media. In the case of linear tape recording, a popular trend is toward multi head, multi-channel fixed head structures with narrowed recording gaps and data track widths so that many linear data tracks may be achieved on a tape medium of a predetermined width, such as one-half inch width tape. To increase the storage density and reduce access time of magnetic tapes, data tracks on the tape are arranged with greater density and the tape is streamed by a tape head at increasingly faster rates.

Magnetic tape heads typically include an active device region formed in raised strips or ridges, commonly referred to as islands, which provide a raised tape support or wear surface with embedded transducers across which the magnetic tape advances. These embedded transducers can be either a recording element for writing information onto a magnetic tape or a reproducing element for reading information off a magnetic tape. An embedded recording element produces a magnetic field in the vicinity of a small gap in the core of the element, which causes information to be stored on magnetic tape as it moves across the support surface. In contrast, a reproducing element detects a magnetic field from the surface of magnetic tape as the tape moves over the support surface.

Generally there is a microscopic separation between an active device region of the tape head, including recording and reproducing elements, and the tape during operation that reduces the strength of the magnetic field coupled to the tape surface during the recording process. During the recording or reproducing process, the small separation reduces the coupling between the tape field and the reproducing element, causing a signal loss. This reduction in magnetic field strength is generally referred to as a “spacing loss.” The magnetic field strength detected by a tape or a reproducing element is proportional to e^{-kd/λ}, where d is the head-to-tape separation, λ is the recording wavelength, and k is a constant. The detected magnetic field strength decreases exponentially both with respect to separation between the tape and the support surface and with respect to recording density (which is inversely related to the recording wavelength). Thus, while a limited amount of head-to-tape separation might be acceptable at low recording densities (100-200 KFCI), smaller transducers used with magnetic tapes of higher recording densities (over 200 KFCI) can tolerate little to no head-to-tape separation.

Further, to allow for faster access and write times, the media may be advanced by a head at speeds ranging from 100 to 1,000 inches per second or more. Increased media speed, however, may entrap air between a support surface of the tape head and the tape. The air may cause increased separation between the magnetic tape and the support surface leading to signal loss and/or excessive tape damage.

The amount of head-to-tape separation may be reduced by ensuring a proper wrap angle of the tape around the head structure to create tension in the tape and increased head-to-tape pressure to reduce the amount of air that may become entrapped. Typical wrap angles may range between about 0.1 and 5 degrees between the advancing tape and the supporting surface of the head structure depending on the particular application.

Increased tension and pressure to prevent spacing has several deleterious consequences. For example, increased tension and pressure may reduce tape life and increase the possibility of tape damage and data loss. Tape damage may lead to increased lateral tape motion and decreased reliability. Also, increased tension and pressure may cause the head structure to wear down more quickly resulting in shortened head life.

Accordingly, it is desired to have relatively high tape-to-head pressure in the active device region (e.g., where the transducer elements are located) and relatively low tape-to-head pressure in other portions of the head. Further, a head structure with reduced manufacturing complexity and cost is desired.

### BRIEF SUMMARY

Exemplary magnetic head assemblies and methods of manufacture are described herein. In one aspect, an exemplary magnetic head structure for use with magnetic storage media as it passes thereby along a longitudinal direction is provided. In one example, the structure includes a support surface having a width along a longitudinal direction and a length along a lateral direction. The structure further includes at least one data transducer disposed with the support surface (e.g., in an active device region of the support surface). The support surface has a longitudinal width aligned with the at least one data transducer and a reduced longitudinal width region offset along the lateral direction from the at least one data transducer. For example, the width of the support surface along a region including the data transducer is greater than a region offset laterally from the at least one data transducer. In one example, multiple reduced width regions are disposed adjacent and/or between a plurality of data transducers.

During a manufacturing lapping process, preferential wear on the head as a result of the different width regions may produce a desired three-dimensional contoured head. In one example, the individual data transducers and/or the active device region is (or becomes) elevated or raised relative to laterally and/or longitudinally offset regions of the support surface. Such a structure may provide for an overall low-pressure support surface, having localized regions (e.g., associated with the data transducers) of low-pressure, low-flying tape-to-head contact for read/write processes.

In another aspect, a tape drive system is described. In one example, the tape drive includes a magnetic head having a varying width support surface for supporting the tape, the support surface having at least one data transducer therein. The support surface has a longitudinal width aligned with the at least one data transducer and a reduced longitudinal width region offset along the lateral direction from the at least one data transducer. The at least one data transducer may be raised or elevated relative to lateral and/or longitudinal offset regions of the support surface.

In another aspect, an exemplary method of manufacturing a magnetic head structure is described. In one example, the method includes forming a support surface having a longitudinal width associated with at least one data transducer and a reduced longitudinal width region offset along a lateral direction from the at least one data transducer. The method further includes lapping the support surface such that the at least one data transducer is raised or elevated relative to at least a portion of the support surface. In one example, the at least one data transducer is raised relative to laterally offset portions of the support surface, and in one example, to laterally offset portions positioned between adjacent data transducers.

In one example, a reduced width region is formed by forming regions in the support surface. In one example, a mask followed by laser ablation is used to remove portions of the support surface. Lapping may include the use of a lapping tape to preferentially wear the reduced width regions of the support surface.

The present invention and its various embodiments are better understood upon consideration of the detailed description below in conjunction with the accompanying drawings and claims.

### BRIEF DESCRIPTION OF THE DRAWINGS

FIG. 1A illustrates a perspective view of an exemplary head structure;

FIG. 1B illustrates a plan view of a portion of the exemplary head structure shown in FIG. 1A;

FIGS. 2A-2B illustrate cross-sectional views of the head structure shown in FIG. 1B before and after processing;

FIGS. 3A-3B illustrate cross-sectional views of the head structure shown in FIG. 1B before and after processing;

FIGS. 4A and 4B illustrate exemplary methods of manufacturing a head structure;

FIG. 5 illustrates a plan view of an exemplary head structure portion having one or more regions formed in the supporting surface;

FIG. 6 illustrates a plan view of an exemplary head structure portion having one or more regions formed in the supporting surface;

FIG. 7 illustrates a plan view of an exemplary head structure portion having outriggers to form an increased width region aligned with the active device region;

FIG. 8 illustrates a plan view of an exemplary head structure portion having a support surface structure aligned with individual data transducer elements of an active device region;

FIG. 9 illustrates a plan view of an exemplary head structure portion having a support surface structure having depressions aligned with individual data transducer elements of an active device region;

FIG. 10 illustrates a plan view of an exemplary head structure portion having lateral and longitudinal increased width portions; and

FIGS. 11 and 12 illustrate plan views of exemplary head structures according to another example.

### DETAILED DESCRIPTION

The following description is presented to enable any person skilled in the art to make and use the inventions. Descriptions of specific materials, techniques, and applications are provided only as examples. Various modifications to the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the scope consistent with the appended claims.

In one example described herein, a self forming (or self adaptive) three-dimensional magnetic storage tape head is provided. The three-dimensional contour of the tape head is designed to provide an air lubricated “near zero” tape-to-head contact pressure for high density recording tape such as low lubricant, particulate smooth media and ME or Metal deposited tape technologies. In one example, the head is designed to self-form into two regions, a first region primarily to support the tape over a relatively low pressure air cushion, and a second region to provide a relatively low pressure, low-flying (e.g., sub-micron air lubrication) tape-to-head interface for efficient read/write processes.

In one example, the head structure includes a data island having short mini-islands or support surfaces formed in the bearing or support surface and laterally offset with respect to an active device region (including the data transducers). The mini-islands are generally narrower than the width of the data island in regions laterally adjacent the active device region. Wear on the support surfaces (via a head lapping process, lapping tape, or during use with a magnetic storage tape) is generally proportional to the pressure of the tape on the surface, which depends on the tension in the tape, the wrap angle, and the width of the support surfaces (along the longitudinal direction of tape transport). Pressure on the support surface will be greater in regions offset from the data transducers by positioning mini-islands (or other features described herein) to create a relative smaller width along the longitudinal direction and laterally offset to the data transducers.

A lapping tape or soft lapping process will preferentially wear the reduced width regions (e.g., including cavities) at a faster rate than the active device region. The reduced width regions may therefore be designed and positioned such that selected portions of the support surface recess relative to other portions, thereby forming a desired three-dimensional contoured surface. In one example, the support surface adapts such that the data transducers are raised or protruded from the support surface to selectively create a region of reduced head-to-tape spacing during use.

An exemplary contoured head having laterally offset mini-islands (or otherwise reduced width regions) may be manufactured at reduced cost and complexity compared to conventional contoured head structures. For example, conventional contoured head structures are generally manufactured with complex contours to produce desired wrap angles and tape-to-head pressure(s). In contrast, an exemplary head structure as described below, which may include substantially flat or contoured support surfaces, may be advantageously manufactured by forming one or more regions in the head assembly at a desired location and width. The support surface is then lapped (or worn by a conventional magnetic tape) and self adapts to take on a three-dimensional surface topology.

Exemplary head structure and methods of manufacture are described in greater detail below. The examples are described as being particularly useful as part of a linear tape head assembly for use in a magnetic tape head having transducer elements that may include suitable cores, such as magneto resistive read elements. Those skilled in the art, however, will understand that the transducer element or core may be a core inductive head, a magnetoresistive read element, a thin film gap head, or other types of data transducer elements including, but not limited to, anisotropic magnetoresistive (AMR), giant magnetoresistive (GMR), or tunneling giant magnetoresistive (TGMR) devices. Additionally, the magnetic media discussed is magnetic recording tape, however, the exemplary heads described and illustrated may be, useful with heads adapted for other media types such as helical scan tape, hard disks, floppy disks, optical recording tape, combinations thereof, and the like.

Exemplary tape drive systems that may include head structures described herein are described, for example, in U.S. Pat. No. 6,188,532, entitled “BACKWARD COMPATIBLE HEAD AND HEAD POSITIONING ASSEMBLY FOR A LINEAR DIGITAL TAPE DRIVE,” and U.S. Pat. No. 6,369,982, entitled “FLOATING TAPE HEAD HAVING SIDE WINGS FOR LONGITUDINAL AND AZIMUTH PLAY BACK WITH MINIMIZED TAPE WRAP ANGLE,” both of which are incorporated by reference herein in their entirety.

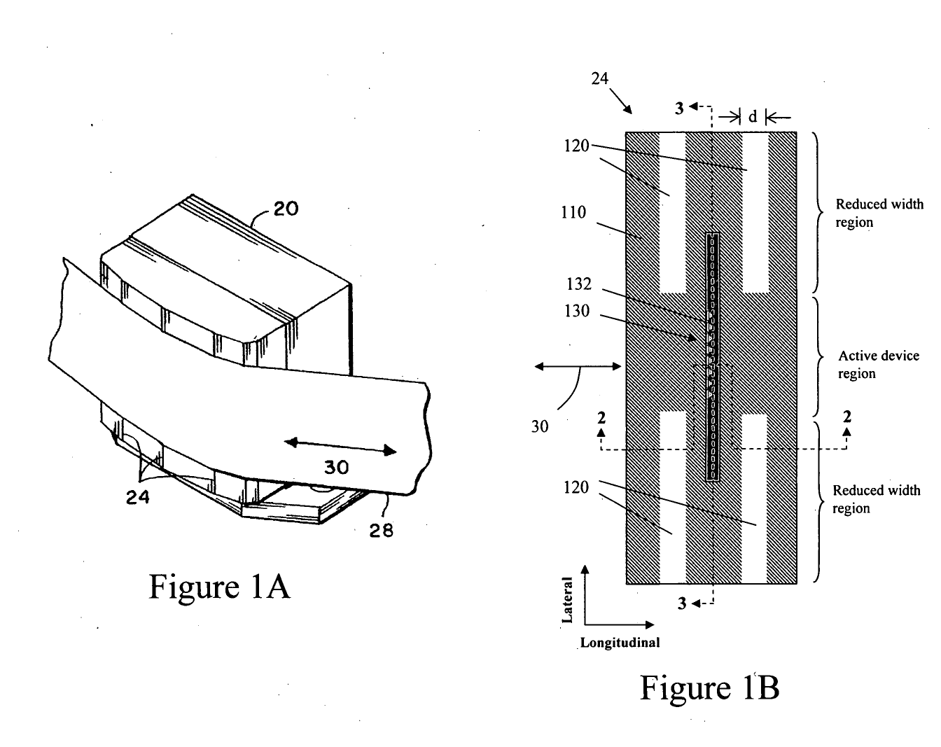

FIG. 1A illustrates a perspective view of an exemplary head 20 including three data islands 24, and FIG. 1B illustrates a plan view of a portion of an exemplary data island 24 shown in FIG. 1A. A magnetic storage tape 28 is shown passing over the surface 22 and data islands 24 of head 20. Generally, tape 28 travels longitudinally by head 20 along a path indicated by arrow 30 and referred to herein as the longitudinal direction. Further, head 20 may move up and down (e.g., transverse to the direction 30 of magnetic storage tape 28 and referred to herein as the lateral direction) to perform read and/or write operations.

In this example, data island 24 protrudes from the surface 22 of head 20 and includes a bearing or support surface 110 for supporting magnetic storage tape 28 as it passes thereover. It is to be understood that support surface 110 may support tape 28 through direct contact or air lubricated contact (i.e., without direct physical contact) and “contact” is intended to encompass either direct or air lubricated support of a tape or other storage medium.

Support surface 110 includes one or more regions 120 and active device region 130 along bond line 132 formed therein. Active device region 130 may include, for example, a column of read and/or write transducers (e.g., 16 read/write transducers). Regions 120 are offset laterally from at least one data transducer of active device region 130 such that the longitudinal width of support surface 110 in these regions is less than the longitudinal width of support surface in regions of active device region 130. Regions 120 are shown generally as linear cavities or regions positioned along the lateral direction; in other examples, regions 120 may be non-linear, have varying widths, and be disposed offset from the lateral direction.

As magnetic storage tape moves longitudinally across support surface 110 (as indicated by arrow 30), the width of the support surface 110 is greater with respect to the active device region 130 than portions of support surface 110 laterally offset (e.g., above and below) active device region 130. In particular, the width along the longitudinal direction is greater in a region encompassing active device region 130 than laterally offset regions including regions 120.

Tension applied to tape 28 (which may include a lapping tape or magnetic storage tape, for example) as tape 28 advances across head 20 and data islands 24 results in a pressure against the support surface 110 that is generally uniform along a particular longitudinal direction. The pressure is generally proportional to the tension and the wrap angle and inversely proportional to the width of the support surface 110 (area) along the longitudinal direction. The pressure may be changed, for example, by modifying the tension in the tape, by modifying the wrap angle of the tape with the support surface, or by modifying the width (along the tape path) of the support surface. In particular, the pressure on the surface is generally increased by increasing the tension in the tape, by increasing the wrap angle of the tape on the support surface, or by decreasing the width of the support surface.

Regions 120, formed laterally offset from the active device region 130, reduce the width of support surface 110 in the longitudinal direction in these regions. The reduced width of support surface 110 in these laterally offset regions will vary the pressure in these regions with respect to active device region 110. Thus, as a tape, whether a magnetic storage tape or lapping tape, passes over data island 24, the pressure in the laterally offset regions (associated with regions 120) will initially have a higher pressure than the active device region 130 and wear at a greater rate. The preferentially wear of the laterally offset regions will result in a three dimensional contoured support surface 110.

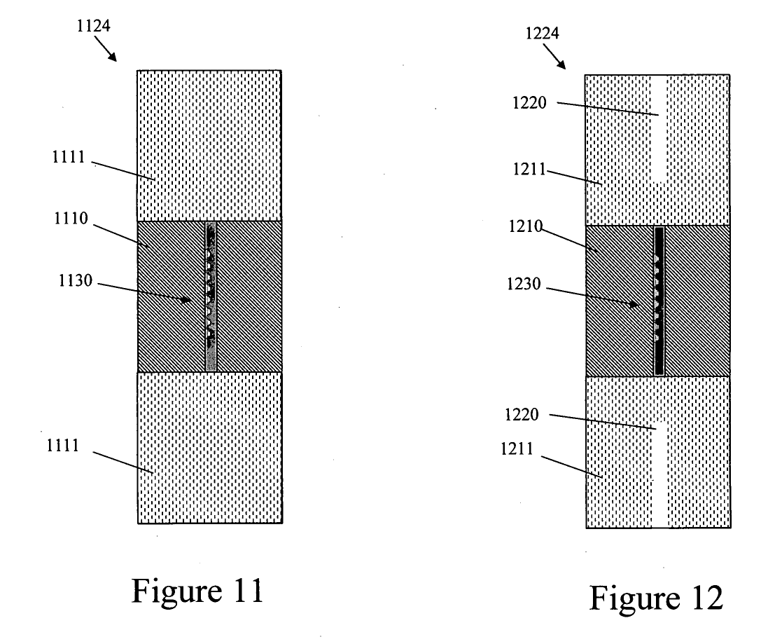

The width “d” of regions 120, as well as the number, orientation, depth, and the like of regions 120 may be varied depending on various factors. In one example, the width “d” of regions 120 is approximately 1 to 5 milli-inches. The material, desired contour, manufacturing processes, and the like may be factors in the design of regions 120. For example, the degree at which support surface 110 is removed during use or lapping may depend on the particular material used for data island 24, which may include, but is not limited to, AlTiC, Zirconia, CaTi, or ferrite materials. For example, more wear resistant materials may require a smaller width support surface 110 to create a desired contour than less resistant materials. In one example, support surface 110 may include different materials having different wear characteristics to achieve desired wear and contours. For example, support surface 110 may include materials having more or less wear resistance in regions laterally offset from active device region 130 (see, e.g., FIGS. 11 and 12).

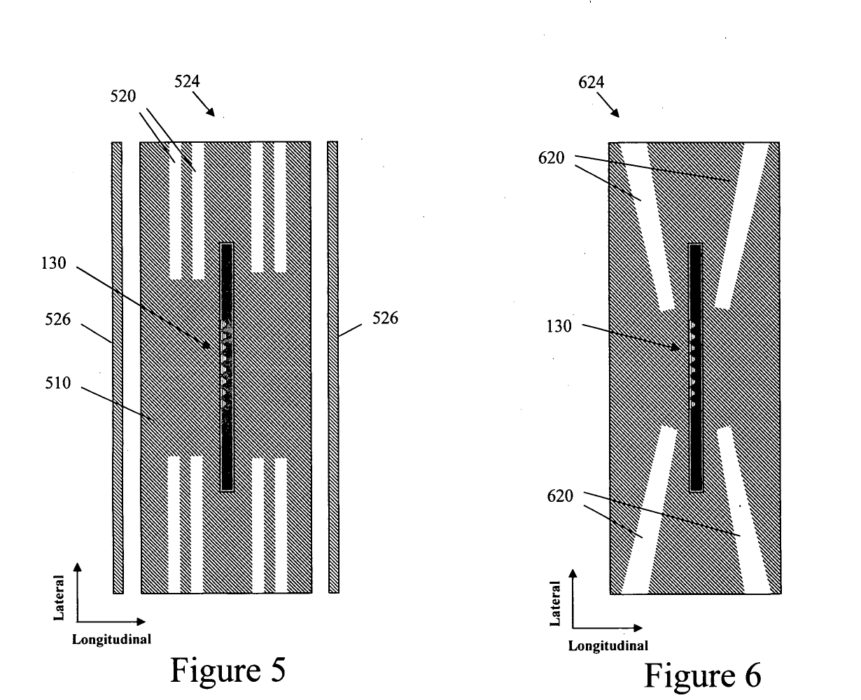

In one example, the wrap angle of the magnetic tape to data island 24 is such to reduce airflow therebetween to minimize separation distances between active device region 130 and the magnetic tape as well as reduce damage to the tape. The wrap angle may be varied and configured by various suitable methods and designs. Further, in other examples, a magnetic head structure may include various other features not shown. For example, outriggers (e.g., data islands without active device regions), outriggers (see, e.g., FIG. 5), and other features may be included to create a desired wrap angle to data island 24.

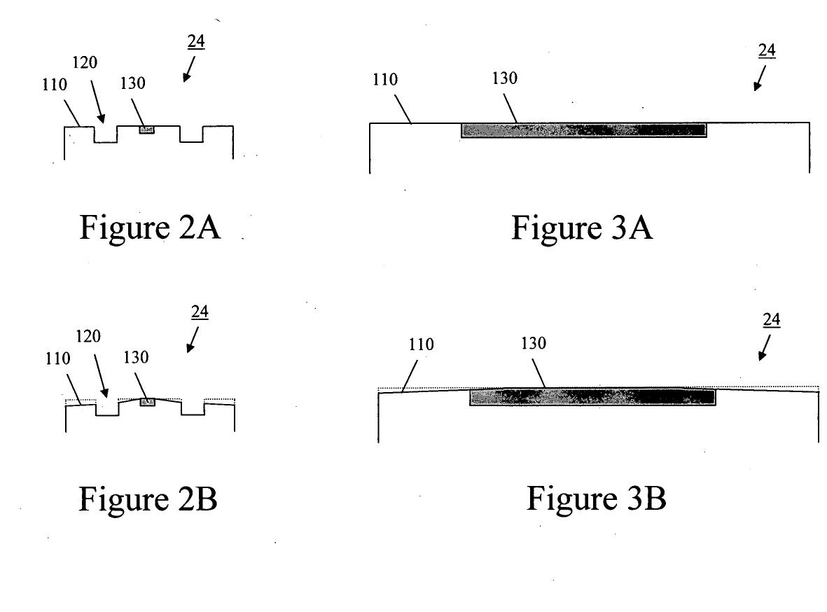

FIGS. 2A, 2B, 3A, and 3B illustrate cross-sectional views of data island 24 according to one exemplary method of manufacture. In this example, the method generally includes forming an active device region 130 and one or more regions 120 in the support surface 110 laterally offset from active device region 130. The support surface 110 is then lapped to remove material at varying rates and form a desired three-dimensional surface contour.

In particular, FIGS. 2A and 3A illustrate data island 24 having regions 120 and active device region 130 formed therein (prior to a lapping process). Any suitable method may be used for forming regions 120 in a portion of the head structure. For example, machining, laser ablation, dry or wet etches, plasma etches, and the like. In one example, a mask is disposed over the support surface 110. Support surface 110 is then etched (e.g., via laser ablation) to remove material from support surface 110 and form regions 120 therein. Additionally, selective deposition of materials may be used create a support surface 110 having one or more regions 120.

Additionally, the depth of regions 120 may be varied; for example, the depth may be sufficient to affect desired wear characteristics during processing or may be deep enough to provide air bleeding during use. In one example, the depth of regions 120 may be relatively shallow, for example, approximately 1 to 3 milli-inches. Shallow regions, which may be reduced in depth or eliminated after further processing (e.g., lapping), may reduce or prevent the build-up of debris during use. In other examples, the regions may be formed relatively deep, for example, through the structure of head 124. Relatively deep regions 120 may assist in air-bleeding and the escape of debris which may fall into regions 120 during use.

Additionally, read and/or write transducers of the active device region 130 may be formed by any suitable method. For example, conventional deposition and etching techniques or the like may be used to form data transducers. In one example, active device region 130 is formed prior to forming regions 120 therein as described above, but in other examples active device region 130 can be formed after forming regions 120.

FIGS. 2B and 3B illustrates the exemplary structure after being lapped. In particular, after regions 120 have been formed, a lapping tape may be used to condition the head structure and create a contoured support surface 110 (compare with pre-lapping surface shown in outline). As discussed above, the positioning and width of regions 120 may be adjusted depending on, for example, the materials, tape speed, and the like to create a predetermined or desired contour support surface. As the lapping tape is streamed across the head, the reduced width regions (laterally offset from active device region 130) wear at a faster rate than the central region including active device region 130.

The resulting head structure shown in FIGS. 2B and 3B includes a raised or protruding active device region 130. Such a surface contour may provide for reduced head-to-tape spacing between a magnetic storage tape and the transducer elements of active device region 130 during use. The remaining portion of support surface 110 is recessed relative to active device region 130, thereby providing relatively low overall pressure between the data island 24 and storage media during use.

The resulting three-dimensional support surface 110 of island 24 may include curvature longitudinally and laterally (e.g., left-to-right, and up-and-down as viewed in FIG. 1B). Further, the active device region 130 may be left protruding or at an apex of the support surface 110. In one example, the radius of curvature in the longitudinal direction is between 0 and 500 milli-inches; in another example between 500 and 1,000 mill-inches. Additionally, in one example, the radius of curvature in the lateral direction is between 0 and 500 milli-inches; in another example, in another example between 500 and 1,000 mill-inches.

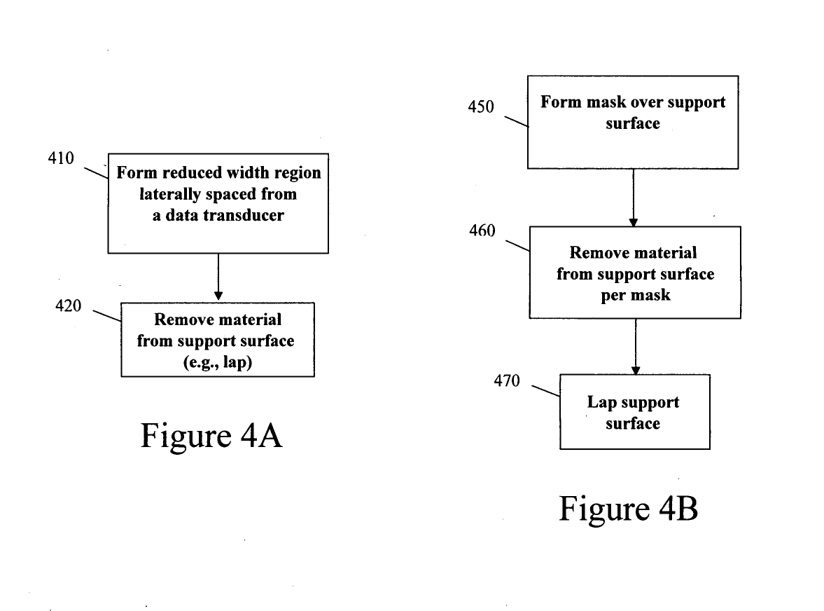

An exemplary method of forming a head structure is illustrated in FIG. 4A. The method includes forming reduced width regions laterally adjacent a region including data transducers as indicated at 410. For example, the reduced width region may be formed by forming one or more regions by material removal or material addition processes.. Material is then removed from the supporting surface of the head structure at 420. In one example, the structure is processes or conditioned with a lapping tape. The lapping tape may include a more corrosive material than typical magnetic storage tape, such as a conventional diamond lapping tape, chromium dioxide, and the like. Additionally, a conventional data tape may be used to lap and remove material from the support surface of the head. Of course, other devices and materials may be used to remove material from the support surface of the head structure.

In one example, the reduced width region is formed by forming one or more regions laterally adjacent the active device region. In such an example, a desired three-dimensional contour surface can be determined based on various principles of operation such as tape speed, recording density, tension, pressure, and the like during expected use. For a given material of the head and wear characteristics thereof, regions may be cut or otherwise formed into the head and offset from at least one of the data transducers of the active device region. A lapping process may then be performed to converge the support surface into the desired three-dimensional geometry.

Another exemplary method of forming a head structure is illustrated in FIG. 4B. In this example, a mask is disposed or formed over the support surface at 450. The mask will be used to remove material from the surface and form regions or other features therein and will be shaped accordingly. For example, a mask may include various shapes, regions, holes, and the like as will be understood from the plan views shown herein. With a suitable mask in place, material from the support surface of the head may be removed at 460. In one example, a laser may be used to etch or ablate material from the support surface through openings in the mask. The use of a mask allows for a wide beam width to quickly process the entire structure. The laser duration and/or power may be controlled to determine amount of material removed and the depth of features formed therein. Similar to the example described above, material is removed to form reduced width regions offset from the data transducers. The support surface may then be lapped at 470 such that the data transducers are left raised relative to the reduced width regions.

FIGS. 5-10 illustrate plan views of exemplary head structure portions having reduced width regions formed in the supporting surface and laterally offset from data transducers. The reduced width regions of the examples described may be formed by suitable material removal or addition processes; for example, laser ablation with or without the use of masks.

FIG. 5 illustrates an exemplary data island 524 having four regions 520 formed in regions laterally above and below a central region including active device region 130. Similar to the examples described above, regions 520 reduce the longitudinal width of regions above and below active device region 130 resulting in a self-adapting contour head structure during processing with a lapping tape or during use. It should therefore be understood that any number of regions 520, including a single region 520, may be used in the regions outside of the active device region 130.

Additionally, data island 524 includes outriggers 526 formed adjacent to data island 524. Outriggers 526 may be configured to create a desired wrap angle of tape to the support surface of data island 524, for example. Accordingly, the longitudinal width, material, spacing, and the like of outriggers 526 may be configured for various purposes and design considerations. Outriggers 526 may be formed by etching a cavity or region to separate support surface 510 therefrom at a desired distance and width.

FIG. 6 illustrates an exemplary data island 624 including regions 620 that are “wedged”, i.e., having a varying width. Regions 620 are further laterally offset, i.e., regions 620 do not run parallel to the lateral direction of structure 624. In other examples, varying width regions aligned with the lateral direction may be used. Regions 620 may provide for varying support surface contours based on the varying longitudinal widths. For example, during a lapping process or use, the regions of the support surface longitudinally aligned with the wide regions of regions 620 will be worn to a greater degree than near narrow regions of regions 620. Such a design may further reduce pressure during use in the lateral regions of data island 624.

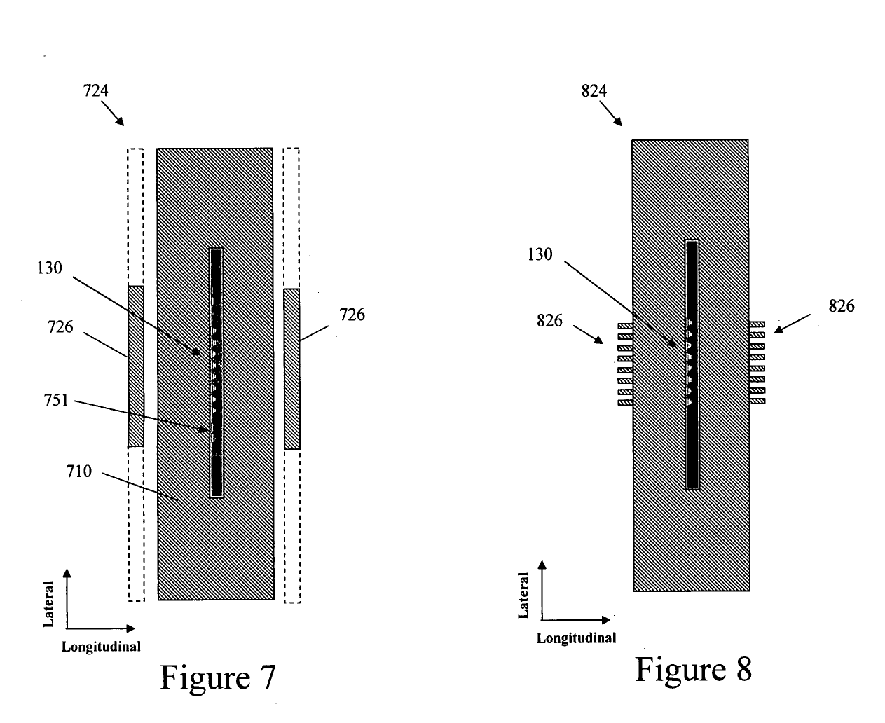

FIG. 7 illustrates a plan view of an exemplary head structure portion 724 having outriggers 726 aligned with active device region 130 to define relative wide and narrow width regions. The reduced width regions are laterally above and below outriggers 726 and device regions 130. The outline is shown to illustrate where a conventional outrigger or mini-outrigger might be positioned and are shown for illustrative purposes only. The shape and position of outriggers 726 may vary from the shape and position and conventional outriggers (see, e.g., the example illustrated in FIG. 8). Additionally, outriggers 726 could be disposed with no separation between support surface 710.

In this example, lapping guides 751 are also shown (and it will be understood that all examples herein may include lapping guides). Generally, it will be desired to form lapping guides 751 in a region having a similar longitudinal width as data transducers of active device region 130 to aid during the lapping process(es). Alternatively, or additionally, lapping guides may be included in the reduced width regions.

FIG. 8 illustrates a plan view of an exemplary head structure portion 824 having a comb support surface structure 826 aligned with data transducers of active device region 130. In this example, the supporting surface of the elements of 826 are positioned to form localized wider longitudinal widths corresponding to the data transducers of active device region 130 and reduced widths laterally offset from each data transducer. For example, reduced width regions are formed between each data transducer of active device region 130, as well as above and below. Surface structure 826 is shown as part of support surface 810, but in other examples, surface structure 826 may be separated from surface 810 (e.g., similar to an outrigger), include regions formed extending into surface 810 (e.g., aligned with space between adjacent data transducers), or the like to form reduced width regions laterally offset from the individual data transducers.

Lapping head structure 824 results in each data transducer being raised relative to laterally offset reduced width regions, including regions between adjacent data transducer elements. Surface structure 826 may further include a supporting surface element aligned with a lapping guide (not shown).

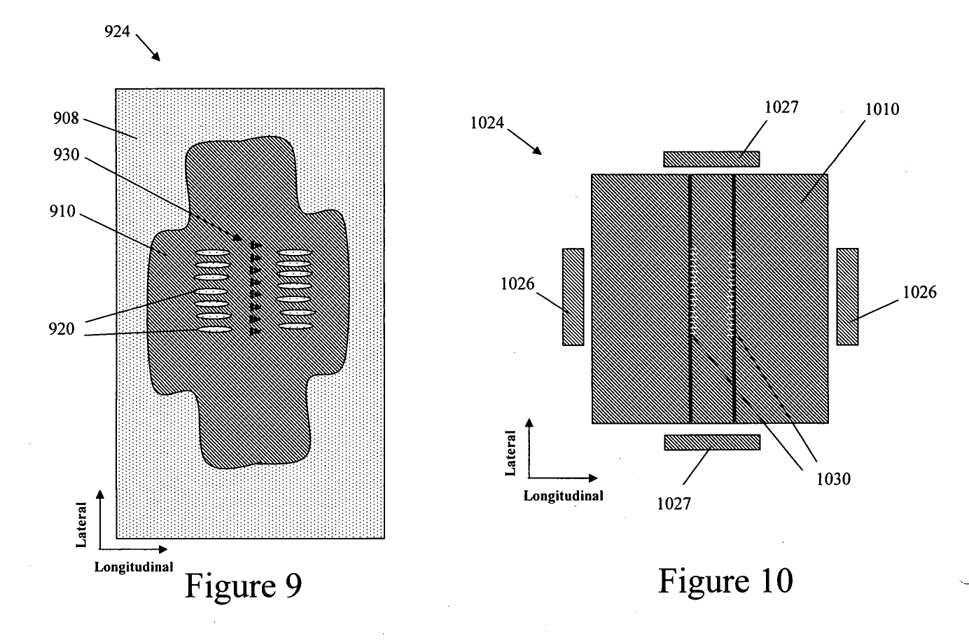

FIG. 9 illustrates a plan view of an exemplary head structure portion 924 according to another example. In this example, the support surface 910 is formed generally having a reduced width region laterally offset from active device region 130. Additionally, support surface 130 has a plurality of depressions or holes 920 formed in support surface 910 and aligned to be offset with respect to individual data transducers of active device region 130 to create localized reduced width regions between the data transducers. The depression or holes 920 may have similar or dissimilar depths as region 908 (which is recessed relative to support surface 910).

In this example, the shape of support surface 910, including holes 920, may be advantageously formed by using a mask and laser ablation. A mask having the shape of support surface 910 and holes 920 may be positioned over support surface 910 and processed with a laser to ablate away region 908 and holes 920 therein. The duration and/or power of the laser may be controlled to control the depth of region 908 and holes 920.

FIG. 10 illustrates a plan view of an exemplary head structure 1024 according to another example. In this example, head structure 1024 includes outriggers 1026 and 1027 spaced laterally and longitudinally from a primary support surface 1010. Similar to FIG. 7, outriggers 1026 are aligned with data transducers of active device region 1030 to create a region of increased longitudinal width associated with active device region 1030 and a region of reduced longitudinal width offset therefrom. In other examples, outriggers 1026 may be formed as part of support surface 1010, in a comb structure (adjacent to, extending from, or extending into support surface 1010), or the like.

Additionally, in this example, the lateral width of support surface 1010 is less than the width of an expected storage tape. Outriggers 1027 are provided for creating a lateral wrap angle, for example, and may be formed to extend the entire longitudinal width of head structure 1024 or may be aligned with active device region 1030. Additionally, outriggers 1027 may be formed as part of support surface—1010, for example, extending from support surface 1010. Lapping head structure 1024 in a lateral direction may similarly preferentially wear portions of the head having a reduced lateral width.

FIGS. 11 and 12 illustrate plan views of exemplary head structure portions according to another example. In these examples, head structures 1124 and 1224 include varying materials to produce preferential wear during a lapping process and a desired three-dimensional contoured surface. In particular, head structure 1124 and 1224 include a relatively harder and/or more wear resistant material 1110 and 1210 aligned laterally with active device regions 1130 and 1230, and a relatively softer and/or less wear resistant material 1111 and 1211 laterally offset from the active device regions 1130 and 1230. Materials 1110, 1111, 1210, and 1211 may be selected from, for example, AlTiC, Zirconia, CaTi, ferrite materials, and the like.

During a manufacturing lapping process, the softer and or less wear resistant material 1110 and 1210 will wear at a faster rate than the laterally aligned material 1111 and 1211. Additionally, as shown in FIG. 12, head structure 1224 may include one or more regions 1220 positioned to create regions of reduced width (in addition to the varying materials). Accordingly, various combinations of varying width regions and varying material regions may be combined to produce desired three-dimensional contours during a manufacturing lapping process.

The above detailed description is provided to illustrate exemplary embodiments and is not intended to be limiting. It will be apparent to those skilled in the art that numerous modification and variations within the scope of the present invention are possible. For example, various examples shown and described in FIGS. 1-3 and 5-12 may be used alone or in combination, as well as alone or in combination with other designs, and the like. Further, numerous other materials and processes not explicitly described herein may be used within the scope of the exemplary methods and structures described as will be recognized by those skilled in the art. Accordingly, the present invention is defined by the appended claims and should not be limited by the description herein.

1. A magnetic head structure for use with magnetic storage media, the structure comprising:
a support surface having a width along a longitudinal direction and a length along a lateral direction, the support surface for supporting the media as the media moves along the longitudinal direction; and
at least one data transducer disposed with the support surface, wherein the support surface has a longitudinal width associated with the at least one data transducer and a reduced longitudinal width region offset along the lateral direction from the at least one data transducer.

2. The magnetic head structure of claim 1, wherein the at least one data transducer is disposed within an active device region of the support surface and the reduced width region is offset along the lateral direction from the active device region.

3. The magnetic head structure of claim 2, wherein the active device region is raised relative to a portion of the support surface laterally offset from the active device region.

4. The magnetic head structure of claim 1, wherein the reduced width region is disposed laterally between two data transducers.

5. The magnetic head structure of claim 1, wherein a plurality of localized reduced longitudinal width regions are disposed between adjacent data transducers.

6. The magnetic head structure of claim 1, wherein the at least one data transducer is raised relative to a laterally offset portion of the support surface.

7. The magnetic head structure of claim 1, wherein the reduced width region comprises at least one cavity formed in the support structure, the at least one cavity laterally offset from the at least one data transducer.

8. The magnetic head structure of claim 7, wherein the at least one cavity has a substantially uniform width and is perpendicular to the longitudinal direction.

9. The magnetic head structure of claim 7, wherein the at least one cavity has a width that varies along its length.

10. The magnetic head structure of claim 1, wherein the support surface includes a first material longitudinally aligned with the at least one data transducer and a second material laterally offset therefrom, the first material and the second material having different wear characteristics.

11. A tape drive system including a magnetic head assembly for writing to and reading from magnetic recording media, comprising:
an actuator for positioning a magnetic head assembly adjacent a tape path, the magnetic head assembly including,
a support surface having a width along a longitudinal direction and a length along a lateral direction, the support surface for supporting the media as the media moves along the longitudinal direction; and
at least one data transducer disposed with the support surface, wherein the support surface has a longitudinal width associated with the at least one data transducer and a reduced longitudinal width region offset along the lateral direction from the at least one data transducer.

12. The tape drive system of claim 11, wherein the reduced width region is disposed laterally between two data transducers.

13. The tape drive system of claim 11, wherein a plurality of localized reduced longitudinal width regions are disposed between adjacent data transducers.

14. The tape drive system of claim 11, wherein the at least one data transducer is raised relative to a laterally offset portion of the support surface.

15. The tape drive system of claim 11, wherein the reduced width region comprises at least one cavity formed in the support structure, the at least one cavity laterally offset from the at least one data transducer.

16. A method for manufacturing a head structure for use with storage media as it passes thereby along a longitudinal direction, the method comprising:
forming a support surface having a longitudinal width associated with at least one data transducer and a reduced longitudinal width region offset along a lateral direction from the at least one data transducer; and
lapping the support surface such that the at least one data transducer is raised relative to at least a portion of the support surface.

17. The method of claim 16, wherein the at least one data transducer is raised relative to a laterally offset portion of the support surface.

18. The method of claim 16, wherein forming the support surface comprises forming at least one cavity in a support surface of a data island, the at least one cavity disposed laterally offset from the at least one data transducer.

19. The method of claim 18, wherein forming the at least one cavity in the support surface comprises laser ablation.

20. The method of claim 16, wherein forming the support surface further comprises disposing a mask over the support surface and removing material from the support surface according to the mask.

21. The method of claim 20, further comprising laser ablation.

22. The method of claim 16, wherein lapping comprises lapping the support surface with a lapping tape.

23. The method of claim 22, wherein lapping results in preferential removal of material in regions associated with the reduced width regions.

24. The method of claim 16, further comprising forming the reduced width region laterally between two data transducers.

25. The method of claim 16, further comprising forming a plurality of localized reduced width regions laterally between adjacent data transducers.

26. The method of claim 16, wherein forming the support surface includes disposing a first material longitudinally aligned with the at least one data transducer and a second material laterally offset therefrom, the first material and the second material having different wear characteristics.
